(19) United States
(12) Patent Application Publication
(10) Pub. No.: US 2014/0042970 A1
(43) Pub. Date: Feb. 13, 2014

(54) INTEGRATED CHARGER SYSTEM

(71) Applicant: Yuri Grigoryants, GLENDALE, CA (US)

(72) Inventor: Yuri Grigoryants, GLENDALE, CA (US)

(21) Appl. No.: 13/570,230

(22) Filed: Aug. 8, 2012

(51) Int. Cl. H02J 7/00

(52) U.S. Cl. 320/114

(57) ABSTRACT

The present invention discloses an integrated charger system that has a construction cordless power tools battery pack and a charger system that is directly, electrically, and mechanically integrated within the construction cordless power tools battery pack to charge an electronic device.

### BACKGROUND OF THE INVENTION

1. Field of the Invention

The present invention relates to an integrated charger system and, in particular, to a cordless tools battery pack that includes an integral Universal Serial Bus (USB) charger outlet receptacle that is used to charge an electronic device, non-limiting example of which may include a mobile phone.

2. Description of Related Art

Most conventional chargers are expensive, bulky (and sometimes fragile), inconvenient to carry, and may require specialty cable/plug for use. The inconvenience of carrying a conventional charger just to charge an electronic device is especially evident for campers or constructions workers where most already require hauling large numbers of camping equipment or construction tools. This is particularly true if the campsite is remote and difficult to reach (requiring very long hikes) or the construction site is faraway or is a high rise building, literally requiring a construction worker to climb a frame of the building still under construction while carrying needed tools, including some bulky, fragile charger with its associated specialty cable/plug.

Accordingly, in light of the current state of the art and the drawbacks to chargers mentioned above, a need exists for an integrated charger system that would be an integral part of a construction cordless power tools battery pack that is used by most campers or construction workers, eliminating the need to purchase a separate, expensive, bulky, fragile charger, and eliminating the inconvenience of carrying the separate, expensive, bulky, fragile charger with its specialty (or non-standard) cable/plug.

### BRIEF SUMMARY OF THE INVENTION

A non-limiting, exemplary aspect of the present invention provides an integrated charger system, comprising:
a construction cordless power tools battery pack; and
a charger system that is directly, electrically, and mechanically integrated within the construction cordless power tools battery pack to charge an electronic device.

Another non-limiting, exemplary aspect of the present invention provides an integrated charger system, comprising:
a construction cordless power tools battery pack that includes:
a housing;
one or more batteries accommodated within the housing;
a main port for charging the one or more batteries and for powering cordless power tools, and
a charger system within the housing that includes at least one Universal Serial Bus (USB) charger outlet receptacle that is fully integrated with the construction cordless power tools battery pack, with the at least one USB charger outlet receptacle extending out of a peripheral wall of the housing.

Such stated advantages of the invention are only examples and should not be construed as limiting the present invention. These and other features, aspects, and advantages of the invention will be apparent to those skilled in the art from the following detailed description of preferred non-limiting exemplary embodiments, taken together with the drawings and the claims that follow.

### BRIEF DESCRIPTION OF THE DRAWINGS

It is to be understood that the drawings are to be used for the purposes of exemplary illustration only and not as a definition of the limits of the invention. Throughout the disclosure, the word “exemplary” is used exclusively to mean “serving as an example, instance, or illustration.” Any embodiment described as “exemplary” is not necessarily to be construed as preferred or advantageous over other embodiments.

Referring to the drawings in which like reference character(s) present corresponding part(s) throughout:

FIG. 1 is a non-limiting, exemplary illustration of an integrated charger system in accordance with the present invention;

FIG. 2 is a non-limiting, exemplary illustration of the integrated charger system of FIG. 1, with a cordless power tool separated from an exemplary construction cordless power tools battery pack in accordance with the present invention;

FIG. 3 is a non-limiting, exemplary illustration of the integrated charger system illustrated in FIGS. 1 and 2, with an electronic device connected to an exemplary construction cordless power tools battery pack for charging in accordance with the present invention;

FIGS. 4A and 4B are a non-limiting, exemplary illustration of the integrated charger system illustrated in FIGS. 1 to 3, illustrating the integrated charger system integrated within an exemplary construction cordless power tools battery pack in accordance with the present invention;

FIG. 5A is a non-limiting, exemplary illustration of the integrated charger system illustrated in FIGS. 1 to 4B, illustrating the integrated charger system elements within an exemplary construction cordless power tools battery pack in accordance with the present invention; and

FIG. 5B is a non-limiting, exemplary illustration of the integrated charger system illustrated in FIGS. 1 to 5A, substantially illustrating a schematic circuit topography of that which is shown in FIG. 5A in accordance with the present invention.

### DETAILED DESCRIPTION OF THE INVENTION

The detailed description set forth below in connection with the appended drawings is intended as a description of presently preferred embodiments of the invention and is not intended to represent the only forms in which the present invention may be constructed and or utilized.

The present invention provides an integrated charger system that is an integral part of a construction cordless power tools battery pack that is used by most construction workers, eliminating the need to purchase a separate, expensive, bulky, fragile charger, and eliminating the inconvenience of carrying the separate, expensive, bulky, fragile charger with its specialty (or non-standard) cable/plug. With the integrated charger system of the present invention, conventional charger cables (e.g., original equipment manufacturer (OEM) cables) that are already provided with the mobile devices may be used to charge the mobile devices.

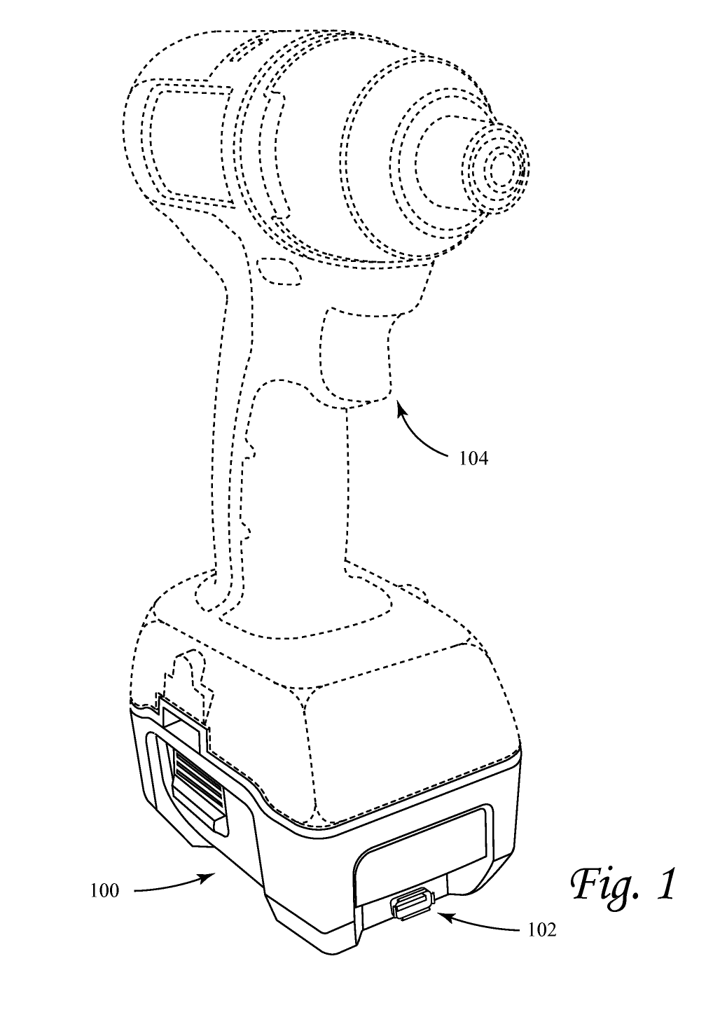

FIG. 1 is a non-limiting, exemplary illustration of an integrated charger system in accordance with the present invention. As illustrated, the integrated charger system of the present invention is comprised of a non-limiting, exemplary construction cordless power tools battery pack 100 and an integrated charger system 102 that is directly, electrically, and mechanically integrated within the exemplary construction cordless power tools battery pack 100 to charge an electronic device. The construction cordless power tools battery packs such as the exemplary illustrated battery pack 100 in the figures are made in a variety of different types, makes, and models by different manufacturers and may be used in camping or construction sites where there is a lack of electric power main, outlet or even basic electric wiring to enable campers or construction workers to power their cordless power tools, flashlight, and mobile devices in accordance with the present invention. As illustrated in FIG. 1, the exemplary construction cordless power tools battery pack 100 of the present invention may be used to power cordless power tools 104 such as the illustrated cordless power drill while still being able to charge an electronic device such as a mobile phone via the integrated charger system 102.

Accordingly, to maintain a mobile device charged, most construction workers or campers no longer need to purchase and carry a separate charger in addition to their basic equipment or tools. In other words, most construction workers or campers can now make extensive use of their mobile devices to communicate with colleagues or family while on the jobsite or camping without having to be concerned about the battery charge of their mobile devices. A charged electronic mobile device is especially important with constructions sites of high-rise buildings where if the mobile device runs out of power or has no power, the construction worker must somehow climb down from the top of the building frame (still under construction) to be able to charge the device (for example, via a car battery or a power generator). This is equally applicable to most remote campsites that require very long hikes, most of which lack a power main or power outlet to be used by campers, compelling campers to hike back to their cars for charging their mobile devices.

With the present invention, construction workers and campers are no longer inconvenienced by carrying a separate conventional charger just to charge an electronic device in addition to hauling large numbers of camping equipment or construction tools. As indicated above, this is particularly true if the campsite is remote and difficult to reach (requiring very long hikes) or the construction site is faraway or is a high rise building, literally requiring a construction worker to climb a frame of the building still under construction while carrying needed tools, including a separate, bulky, fragile conventional charger with its associated specialty cable/plug.

The integrated charger system of the present invention is fully integrated with a construction cordless power tools battery pack (an already required equipment extensively used by most construction workers and campers), eliminating the need for separate chargers.

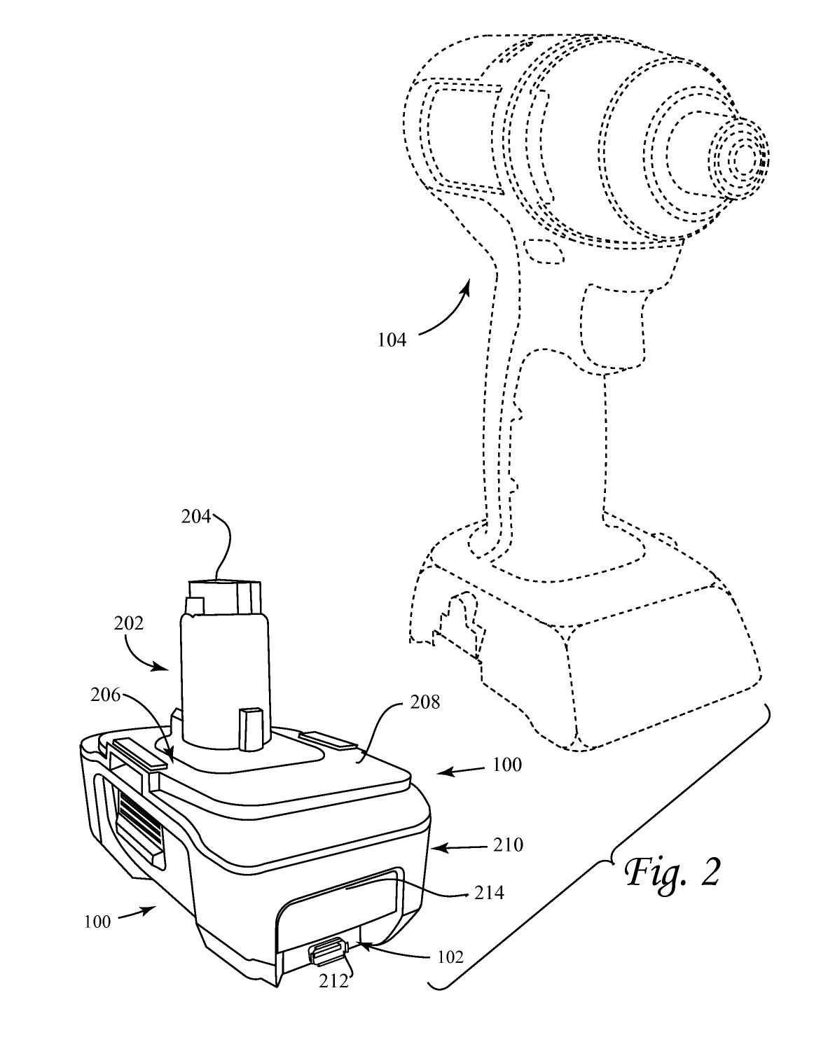

FIG. 2 is a non-limiting, exemplary illustration of the integrated charger system of FIG. 1, with a cordless power tool separated from an exemplary construction cordless power tools battery pack in accordance with the present invention. As illustrated in FIG. 2, the construction cordless power tools battery pack 100 used as an example to illustrate the invention includes a housing that may have a top piece 206 that includes an exterior surface 208 that has a protruded elongated stem 202 at a distal end of which is the main port 204. It should be noted that the construction cordless power tools battery pack 100 is only used as an example. Other types, makes, and models of construction cordless power tools battery packs exist that may not have the same type of construction for a main port 204, or may have a single piece constructions, but may equally be used with the charger system of the present invention. To continue with the illustrated example of a construction cordless power tools battery pack, the housing further includes a bottom piece 210 that includes at least one USB charger outlet receptacle 212 within and extending out of a bottom peripheral wall 214 of the bottom piece 210 of the housing. As illustrated in FIGS. 1 and 2, the exemplary construction cordless power tools battery pack 100 may be used in a conventional manner to power a cordless power tool 104 and further, may itself be charged in a conventional manner via its main port 204. This equally applies to most other types, makes, or models of construction cordless power tools battery packs, and should not be limited to the illustrated pack 100.

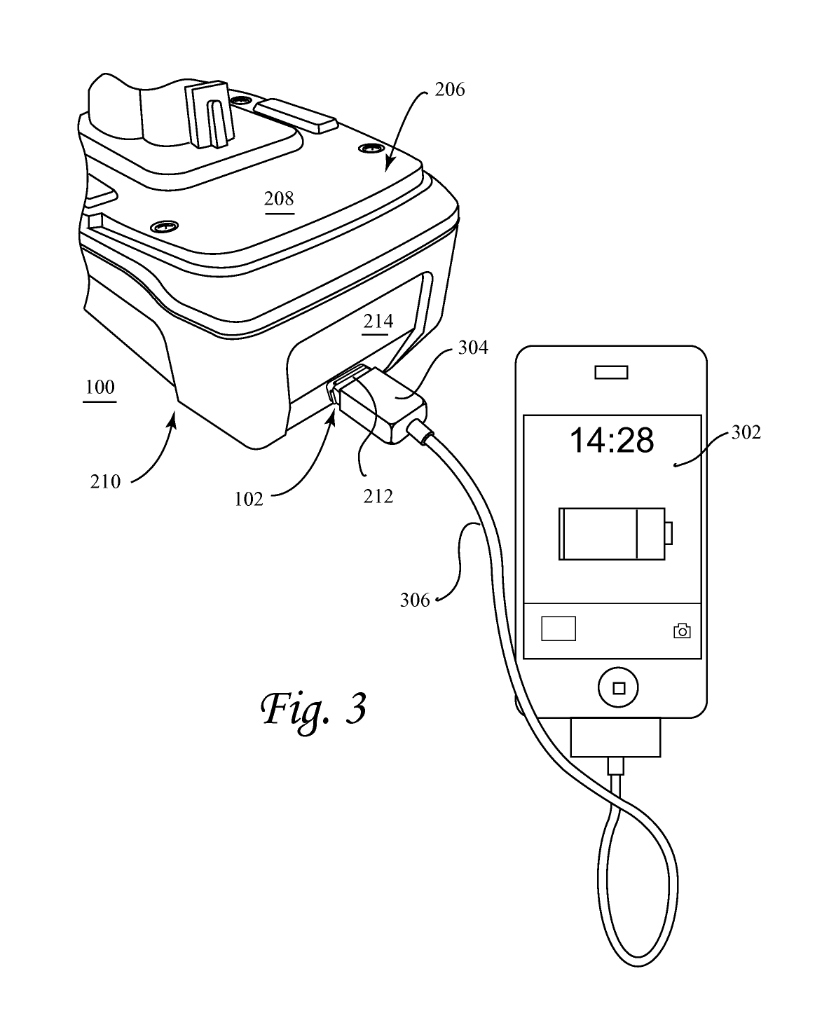

FIG. 3 is a non-limiting, exemplary illustration of the integrated charger system illustrated in FIGS. 1 and 2, with an electronic device connected to the construction cordless power tools battery pack for charging in accordance with the present invention. As illustrated in FIG. 3, with integrated charger system 102 of the present invention, users may simply connect a USB plug 304 of a USB charger cable 306 of an electronic device 302 to the USB charger outlet receptacle 212 of construction cordless power tools battery pack 100 for charging the electronic device 302. It should be noted that it is only for clarity that FIG. 3 exemplarily illustrates an electronic device 302 being charged by the construction cordless power tools battery pack 100 while the cordless power tool 104 is removed. In other words, the construction cordless power tools battery pack 100 may be used to power a cordless power tool while charging the electronic device 302 or alternatively, while itself is being charged via its main port 204. Stated otherwise, the construction cordless power tools battery pack 100 may continue to carry on functionalities associated with the construction cordless power tools battery pack 100 while still charging an electronic device in accordance with the present invention.

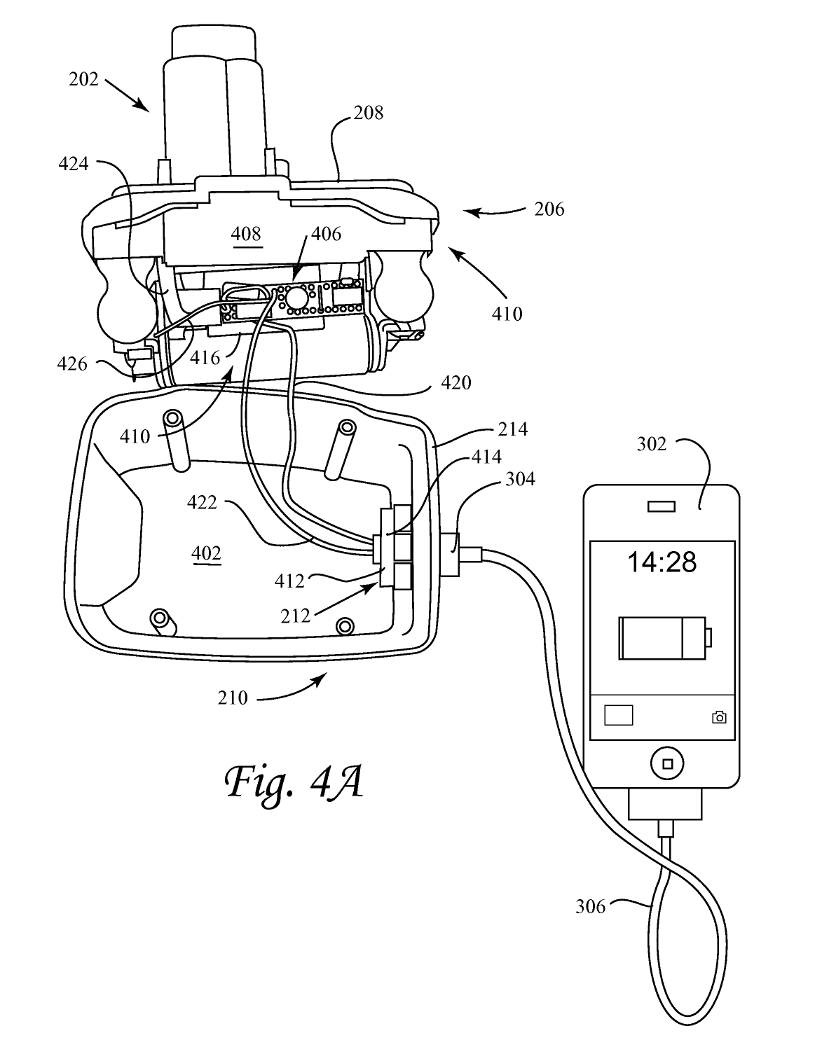

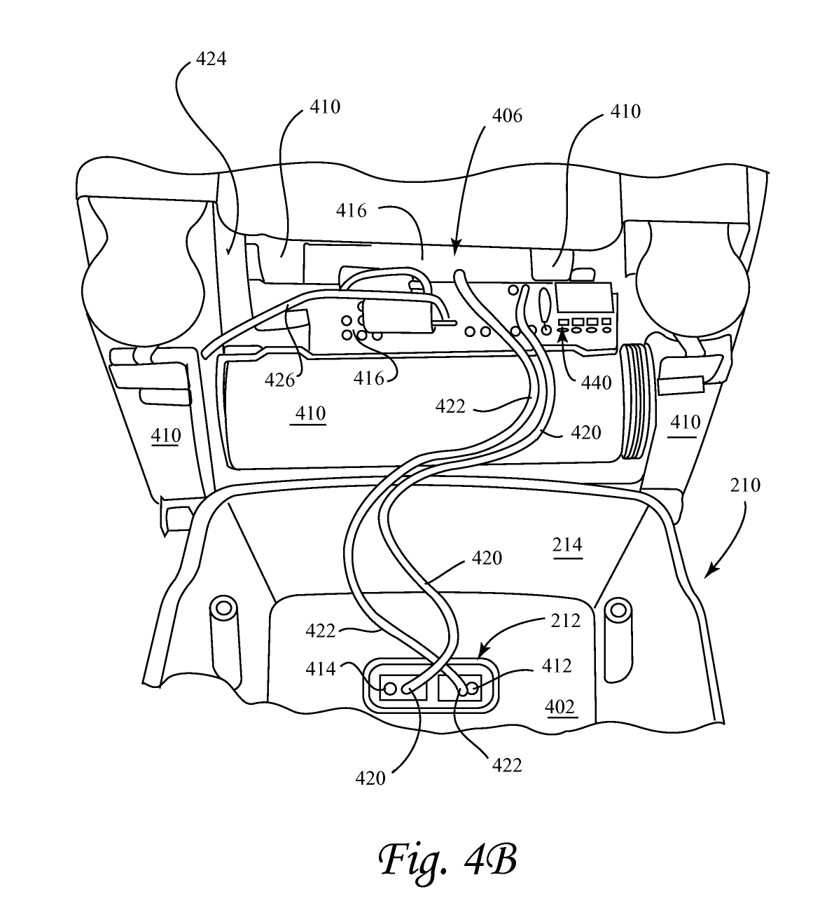

FIGS. 4A and 4B are a non-limiting, exemplary illustration of the integrated charger system illustrated in FIGS. 1 to 3, illustrating the integrated charger system integrated within an exemplary construction cordless power tools battery pack in accordance with the present invention. The construction cordless power tools battery pack 100 includes one or more batteries 410 accommodated within the housing, with the one or more batteries assembled onto an internal battery support structure 416 (at least in the type, make, and model battery pack illustrated). The top piece 206 of the housing for the non-limiting, exemplary type, make, and model construction cordless power tools battery pack 100 includes a top inner cavity defined by top peripheral walls 408 perpendicular to the exterior surface 208 that partially house the batteries 410, with the peripheral walls 408 also engaging the bottom piece 210. Again, it should be emphasized that other types, makes, or models of construction cordless power tools battery packs exist that may have a different housing structure that may be used with the disclosed charger system in accordance with the present invention. The bottom piece 210 includes a bottom inner cavity 402 defined by bottom peripheral walls 214 that partially accommodates the batteries 410 and includes the at least one USB charger outlet receptacle 212 within and extending out of one of the bottom peripheral wall 214 of the bottom piece 210 of the housing. As further illustrated in FIGS. 4A and 4B, the USB regulator circuit 406 is electrically and mechanically connected with USB power ports 412 and 414 of the USB charger outlet receptacle 212 via respective power wires 422 and 420. The USB regulator circuit 406 is further electrically and mechanically connected with the batteries 410 via power wires 424 and 426. The USB regulator circuit 406 is supported on a Printed Circuit Board (PCB) 440. The PCB 440 is physically connected with the internal battery support structure 416, and is nestled in between a longitudinal axis of a set of batteries 410. The position and orientation of the PCB 440 should not be limiting and may be varied, dictated by the type, make, and model of the construction cordless power tools battery pack used.

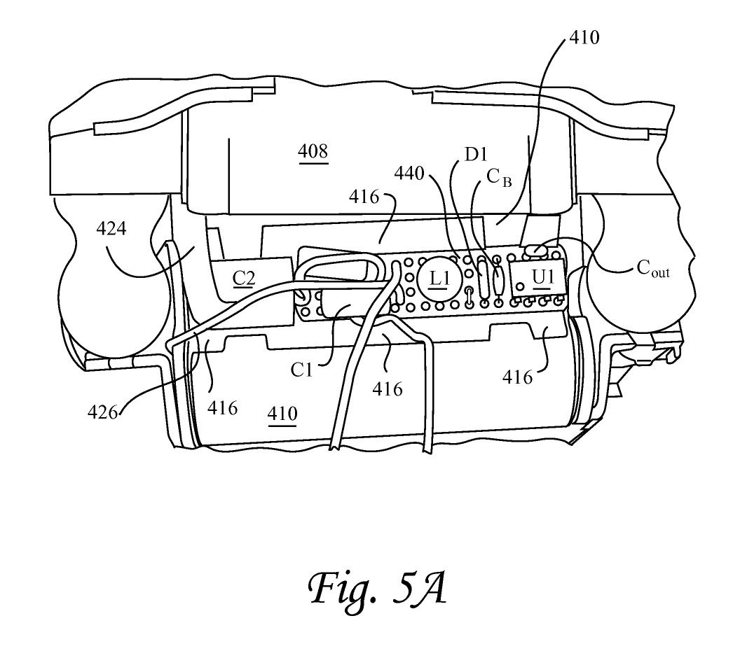

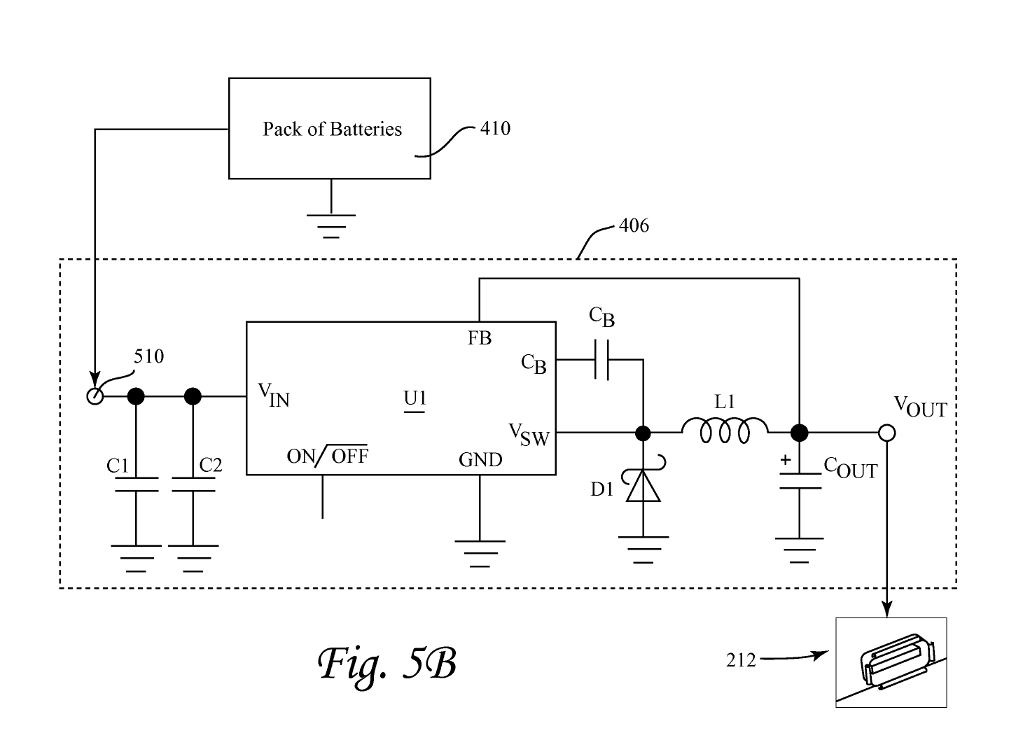

FIG. 5A is a non-limiting, exemplary illustration of the integrated charger system illustrated in FIGS. 1 to 4B, illustrating the integrated charger system elements within an exemplary construction cordless power tools battery pack in accordance with the present invention, and FIG. 5B is a non-limiting, exemplary illustration of the integrated charger system illustrated in FIGS. 1 to 5A, substantially illustrating a schematic circuit topography of that which is shown in FIG. 5A in accordance with the present invention. As illustrated in FIGS. 5A and 5B, the USB charger outlet receptacle 212 is electrically and mechanically coupled with one or more batteries 410 through the USB regulator circuit 406 that includes a well known step down voltage regulator U1 that steps down power input from the one or more batteries 410 and output a substantially constant DC 5 V power to the USB charger outlet receptacle 212 to power and charge the electronic device 302 with the USB cable 306 that is connected to the USB charger outlet receptacle 212. The USB regulator circuit 406 further includes a main input 510 that is coupled with an output of the battery pack 410. Also included is a capacitor set C1 and C2 that reduce power fluctuation and maintain a constant level of voltage, generating a conditioned voltage at the main input 510. The capacitor set C1 and C2 may be thought of as filtering and buffering capacitors to maintain a constant level of voltage at Vin of the step down voltage regulator U1. The issue with batteries used to charge an electronic device is that as they discharge, their output power is commensurately reduced. This means that the level of output power from the batteries 410 experienced at Vin terminal of the step-down voltage regulator U1 continuously varies (is continuously reduced due to battery discharge). The Vin terminal of the step-down voltage regulator U1 requires a substantially constant (and not varying) level of input voltage. Accordingly, the capacitor set C1 and C2 are used and function as filtering and buffering capacitors to maintain a substantially constant level of voltage at Vin of the step down voltage regulator U1, regardless of fluctuations of battery output power. As further illustrated, the capacitors have a first end coupled with the main input 510 and a second end coupled with the ground GND. The step-down voltage regulator circuit U1 and its remaining interconnections (capacitor C_{B}, diode D1, inductor L1, and capacitor C_{OUT}) is very well known and disclosed in the publication titled “Simple Switcher Power Converter High Efficiency 500 mA Step Down Voltage Regulator,” to Texas Instruments, the entire disclosure of which is expressly incorporated by reference herein. The step-down voltage regulator circuit U1 includes the first input terminal Vin connected to the main input 510 for receiving the conditioned voltage, and outputs a reduced voltage to the USB charger outlet receptacle 212 for chagrining the electronic device 302.

Although the invention has been described in considerable detail in language specific to structural features and or method acts, it is to be understood that the invention defined in the appended claims is not necessarily limited to the specific features or acts described. Rather, the specific features and acts are disclosed as exemplary preferred forms of implementing the claimed invention. Stated otherwise, it is to be understood that the phraseology and terminology employed herein, as well as the abstract, are for the purpose of description and should not be regarded as limiting. Therefore, while exemplary illustrative embodiments of the invention have been described, numerous variations and alternative embodiments will occur to those skilled in the art. For example, there are a large number of different types, makes, and models of construction cordless power tools battery packs and associated power tools available from a large number of different manufacturers too numerous to mention or illustrate and hence, the illustrated construction cordless power tools battery pack 100 and its associated tool illustrated is merely used as an example, but without any limitations. In fact, most other types, makes, and models of construction cordless power tools battery packs available may be used without departing from the spirit and scope of the present invention. A non-limiting, non-exhaustive listing of other types, makes, and models of construction cordless power tools battery packs available may include the construction cordless power tools battery pack disclosed in U.S. Pat. No. 7,357,526, the entire disclosure of which is expressly incorporated by reference herein.

As another example, although only a single USB charger outlet receptacle is illustrated throughout the figures for clarity and convenience, any number of USB charger outlet receptacles may be implemented and incorporated with a construction cordless power tools battery pack in accordance with the present invention. Both the position and or orientation of the USB charger outlet receptacles may be varied, and should not be limited to the illustrated position and orientation exemplarily shown throughout the figures. The USB regulator circuit 406 and its associated Printed Circuit Board 440 may be accommodated within a dedicated compartment within a housing of a construction cordless power tools battery pack. Further, a housing of a construction cordless power tools battery pack may be provided with grid-like openings to facilitate ventilation and cooling (if need be). Such variations and alternate embodiments are contemplated, and can be made without departing from the spirit and scope of the invention.

It should further be noted that throughout the entire disclosure, the labels such as left, right, front, back, top, bottom, forward, reverse, clockwise, counter clockwise, up, down, or other similar terms such as upper, lower, aft, fore, vertical, horizontal, oblique, proximal, distal, parallel, perpendicular, transverse, longitudinal, etc. have been used for convenience purposes only and are not intended to imply any particular fixed direction or orientation. Instead, they are used to reflect relative locations and/or directions/orientations between various portions of an object.

In addition, reference to “first,” “second,” “third,” and etc. members throughout the disclosure (and in particular, claims) is not used to show a serial or numerical limitation but instead is used to distinguish or identify the various members of the group.

In addition, any element in a claim that does not explicitly state “means for” performing a specified function, or “step for” performing a specific function, is not to be interpreted as a “means” or “step” clause as specified in 35 U.S.C. Section 112, Paragraph 6. In particular, the use of “step of,” “act of,” “operation of,” or “operational act of” in the claims herein is not intended to invoke the provisions of 35 U.S.C. 112, Paragraph 6.

What is claimed is:

1. An integrated charger system, comprising:
a construction cordless power tools battery pack; and
a charger system that is directly, electrically, and mechanically integrated within the construction cordless power tools battery pack to charge an electronic device.

2. The integrated charger system as set forth in claim 1, wherein:
the construction cordless power tools battery pack includes:
a housing;
one or more batteries accommodated within the housing;
a main port for charging the one or more batteries and for powering cordless power tools, and
the charger system including a Universal Serial Bus (USB) charger outlet receptacle that is fully integrated with the construction cordless power tools battery pack.

3. The integrated charger system as set forth in claim 2, wherein:
the housing includes:
an inner cavity defined by peripheral walls that partially accommodates the batteries and includes at least one USB charger outlet receptacle within and extending out of a peripheral wall of housing.

4. The integrated charger system as set forth in claim 3, wherein:
the USB charger outlet receptacle is electrically and mechanically coupled with a Printed Circuit Board (PCB).

5. The integrated charger system as set forth in claim 4, wherein:
the USB charger outlet receptacle is electrically and mechanically coupled with one or more batteries through the USB regulator circuit that includes a step down voltage regulator that steps down power input from the one or more batteries and output a substantially constant DC 5 V power to the USB charger outlet receptacle to power and charge the electronic device with a USB cable that is connected to the USB charger outlet receptacle.

6. The integrated charger system as set forth in claim 5, wherein:
the USB regulator circuit further includes:
a main input that is coupled with an output of the battery pack;
a capacitor that reduces power fluctuation and maintains a constant level of voltage, generating a conditioned voltage at the main input;
the capacitor has a first end coupled with the main input and a second end coupled with the ground GND;
the step-down voltage regulator circuit having a first input terminal Vin connected to the main input for receiving the conditioned voltage, and outputting a reduced voltage to the USB charger outlet receptacle for chagrining the electronic device.

7. An integrated charger system, comprising:
a construction cordless power tools battery pack that includes:
a housing;
one or more batteries accommodated within the housing;
a main port for charging the one or more batteries and for powering cordless power tools, and
a charger system within the housing that includes at least one Universal Serial Bus (USB) charger outlet receptacle that is fully integrated with the construction cordless power tools battery pack, with the at least one USB charger outlet receptacle extending out of a peripheral wall of the housing.
